(19) United States
(12) Patent Application Publication
(10) Pub. No.: US 2008/0236159 A1
(43) Pub. Date: Oct. 2, 2008

(54) CYCLOIDAL POWER GENERATOR

(76) Inventor: Glenn Martin Tierney, Huntsville, AL (US)

Correspondence Address: NYDEGGER & ASSOCIATES, 348 OLIVE STREET, SAN DIEGO, CA, 92103, US

(21) Appl. No.: 11/692,045

(22) Filed: Mar. 27, 2007

(51) Int. Cl. F03B 13/14; F03B 13/12

(52) U.S. Cl. 60/499; 290/53

(57) ABSTRACT

A cycloidal generator is provided to generate power from energy in a tidal flow. The generator includes a plurality of blades mounted on a hub for collective rotation about a hub axis, and a center shaft is positioned with its central axis oriented perpendicular to the tidal flow. Interconnecting the center shaft with each individual blade on the hub is a gear assembly that cyclically rotates the blade for autorotation of the hub in response to the tidal flow. A link assembly is also provided that interconnects the hub with the center shaft for rotation of the center shaft and the consequent generation of power in response to rotation of the hub.

### FIELD OF THE INVENTION

The present invention pertains generally to power generators. More particularly, the present invention pertains to systems and methods for using tidal movements for generating power. The present invention is particularly, but not exclusively, useful as a cycloidal tidal power generator that cyclically varies the respective angles of attack on a plurality of blades relative to a tide, to maintain a same direction rotational motion for the generation of power.

### BACKGROUND OF THE INVENTION

In order to generate power, it is necessary to have a source of energy. As is well known, there are many such sources, for example, fossil fuels. In recent years, however, there has been increased interest in so-called natural sources of energy, such as solar energy or the wind. Another source of natural energy which has great potential, but which has been somewhat overlooked, is the ocean. More particularly, tidal movements in large bodies of water (e.g. the ocean) are known to manifest vast amounts of energy. Heretofore, the problem has been to determine how best this energy can be harnessed.

It is well known that power can be generated whenever something is moved (e.g. the armature of an electric power generator). When tidal movements are considered for this purpose, the task then becomes a matter of converting the movement of the tide (i.e. energy) into the movement of a structure that will generate power (e.g. an armature). In this context, and in accordance with well known aerodynamic and hydro-dynamic principles, it is known that the interaction of a fluid flow (gas or liquid) with an airfoil-like structure (e.g. a blade) will generate forces on the structure (blade) that can cause it to move. For example, a windmill generates power in response to air movements (i.e. the wind). Similarly, the rotor of an autogiro provides lift in response to airflow through the rotor (note: the rotor itself is un-powered). Further, helicopters, when they experience a power loss, can safely descend to a landing as the upward flow of air through the rotor slows its descent. In each of these examples, performance is accomplished by a phenomenon known as “autorotation.” These examples, however, all involve structures that react to air flow. In an underwater environment (e.g. when confronting a tidal flow), a more robust and compact structure will, most likely, be more appropriate. Nevertheless, autorotation is still a key concept.

Autorotation, as the word indicates, is a phenomenon involving an un-powered rotation of a structure (i.e. a blade). Stated differently, with autorotation, the rotation is automatic and requires no external source of power. Essentially, this happens because the aerodynamic (hydro-dynamic) force that is generated on the blade is oriented with a component that will cause the blade to continue moving in a desired direction. For purposes of generating power, it is desirable that such forces be substantially constant, are effective regardless of the direction of fluid flow, and cause the blade to continuously move in a same direction.

In light of the above, it is an object of the present invention to provide a tidal power generator that is effective in transforming the energy of tidal movements into useful power. Another object of the present invention is to provide a tidal power generator that is compact, robust and capable of continuous operation for extended periods of time. Still another object of the present invention is to provide a tidal power generator that is relatively easy to manufacture, is very simple to operate, and is comparatively cost effective.

### SUMMARY OF THE INVENTION

In accordance with the present invention, a cycloidal generator is provided for converting the energy of a tidal movement into useful power. To do this, the present invention includes a plurality of airfoil-shaped blades that are mounted, in parallel, on a substantially disk-shaped hub. As so mounted, the blades individually follow along a same circular blade path during their rotation about a common hub axis. This rotation of the blades about the hub axis is caused by the action of the tidal flow over the blades. In turn, this action on the blades rotates the hub. As intended for the present invention, a rotation of the hub is transferred directly to a center shaft for rotation of the center shaft about a central axis and, thus, for the generation of power.

Structurally, the center shaft is individually connected to each blade via a gear assembly, and it is separately connected to the hub via a link assembly. Importantly, the gear assembly and link assembly act together to allow the hub, and its hub axis, to move relative to the center shaft. During any such movement, however, the hub axis remains parallel to the central axis. Further, the distance between the hub axis and the central axis is limited by the link assembly, and does not exceed a distance “d.” As intended for the present invention, this distance “d” will normally be less than the radius “r” of the gear.

The gear assembly is provided to cyclically rotate each blade about its own individual blade axis. More specifically, the angle “α” each blade makes relative to the blade path will vary continuously as the blade travels on the blade path. Specifically, this variation in the angle “α” is dependent on the distance of the hub axis from the central axis of the center shaft. Further, during each revolution of the hub, the blade angle “α” will reciprocally vary between a positive angle β and a negative angle φ. In general, the maximum magnitude of these angles (i.e. β and φ) will be equal. Thus, β=+α and φ=−α. An important consequence of this variation is that the plurality of blades will, collectively, establish an autorotation effect.

In detail, the gear assembly has three intermeshing gears for each respective blade. These include: a common center gear that is affixed to the center shaft; a blade gear that is affixed to each blade; and a middle gear that is engaged between the center gear and the blade gear. Together, the various gears act to allow for variations in the distance “d” between the hub axis and the central axis.

As indicated above, the link assembly is provided to cause a rotation of the center shaft in response to a rotation of the hub. Functionally, the link assembly is also provided to maintain the gear meshing required for operation of the gear assembly. Structurally, the link assembly involves numerous links. These include a proximal hub link and a distal hub link. For these links, one end of the proximal hub link is pivotally attached to a peripheral point on the center gear and one end of the distal hub link is pivotally attached to the hub. The free ends of the proximal and distal hub links are then connected together to establish a free pivot. Also included in the link assembly is a gear link that interconnects the blade gear with the middle gear. Additionally, a reference link interconnects the middle gear with the free pivot. With this construction, the link assembly and the gear assembly, in concert, rotate the center shaft when the hub is rotated.

For its operation, the cycloidal generator is positioned on the floor of a body of water; preferably in the coastal area of a sea or ocean where the water is known to have a substantially continuous flow (i.e. tidal movements). More specifically, the generator is positioned so that the central axis of the center shaft, the hub axis of the hub, and the respective blade axes of the plurality of blades will all be substantially perpendicular to the direction of the tidal flow. Importantly, the generator is anchored to the floor in a manner that will hold the center shaft stationary. With the generator positioned in this manner, the tidal flow will urge against the plurality of blades to collectively move the hub along with the blades, and thus the hub axis also, in a direction downstream from the central axis. Note: the actual direction of the tidal flow is immaterial and, indeed, is expected to vary. Nevertheless, the hub and its hub axis will always be moved downstream, relative to the direction of tidal flow. Furthermore, this movement will be stopped by the link assembly, only when the hub axis is at the distance “d” from the central axis.

During operation of the cycloidal generator, the gear assembly will reciprocally vary the angle “α” of each blade as it travels on the blade path. Specifically, this variation will be between a maximum positive angle (i.e. α=β) at the most upstream position of the blade, and a maximum negative angle (i.e. α=φ) at its most downstream position. At both of these extreme positions, however, hydraulic forces on the blade will move the blade in a same direction on the blade path. Moreover, at intermediate positions, the cyclically varying angle “α” will maintain the autorotation effect, and will cause the hub to continuously rotate in a same direction. This will be so, regardless of the direction of tidal flow. The result is: autorotation of the hub creates forces that are transferred by the link assembly, and applied, as a torque on the center shaft. The rotation of the center shaft is then used to generate power.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a cycloidal tidal generator in accordance with the present invention;

FIG. 2 is a partial cross section view of a portion of the generator as seen along the line 2-2 in FIG. 1;

FIG. 3 is a top plan view of a gear assembly of the present invention as seen along the line 3-3 in FIG. 1;

FIG. 4 is a drawing of fluid dynamic forces acting on a blade, as the blade is moving through a fluid medium;

FIG. 5 is a schematic drawing of the influence a tide has on the hub of the generator;

FIG. 6 is a schematic drawing of the orientational relationship a blade has as it moves on its blade path in accordance with the present invention;

FIG. 7A is a schematic drawing of a gear assembly when its associated blade is in a downstream position relative to tidal flow; and

FIG. 7B is a schematic drawing of a gear assembly when its associated blade is in an upstream position relative to tidal flow.

### DESCRIPTION OF THE PREFERRED EMBODIMENTS

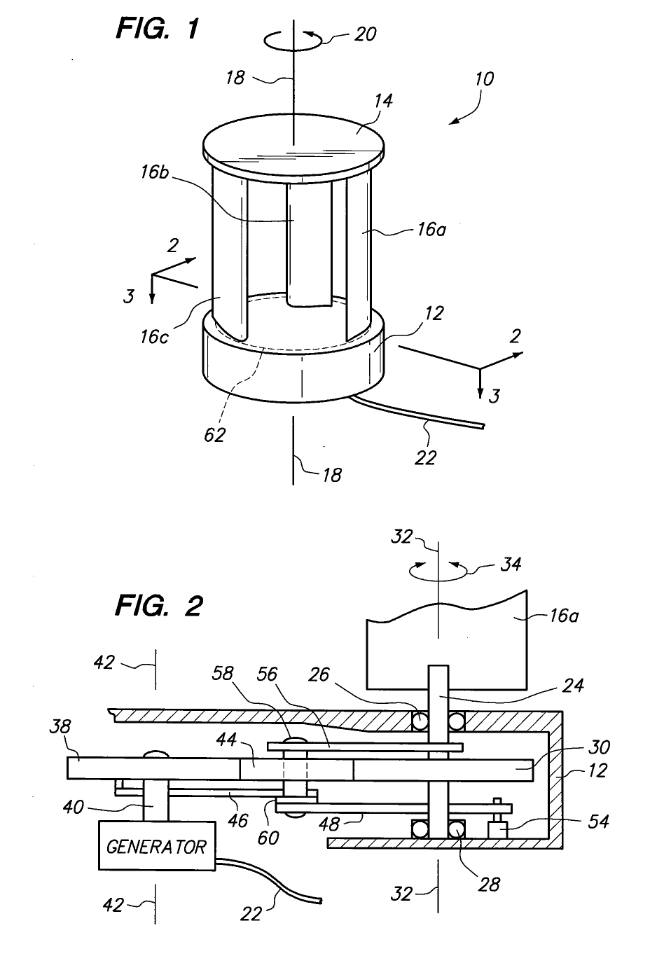

Referring initially to FIG. 1, a cycloidal tidal power generator in accordance with the present invention is shown and is generally designated 10. As shown, the generator 10 includes a disk-shaped hub 12 and an end plate 14. A plurality of blades 16a, 16b, and 16c are mounted between the hub 12 and end plate 14. The blades 16a-c are of equal length and are mounted substantially parallel to each other. Further, though pivotally connected to both the hub 12 and end plate 14, the blades 16a-c will rotate with the hub 12 and end plate 14 about a common hub axis 18. This rotation will be in a direction exemplified by the arrow 20. FIG. 1 also shows that the generator 10 is connected to a power cable 22 that will extend from the generator 10 to an on-shore power plant (not shown).

Using the blade 16a as an example, FIG. 2 shows that the blade 16a is fixedly attached to a blade shaft 24. The blade shaft 24 is then mounted on the hub 12 by an upper bearing 26 and a lower bearing 28. The blade shaft 24 is also shown in FIG. 2 to be fixedly attached to a blade gear 30. Importantly, although the bearings 26 and 28 allow the blade shaft 24, blade gear 30 and blade 16a to rotate about a blade axis 32, they also retain these components on hub 12. With this construction, the blade 16, blade gear 30, and blade shaft 24 are able to reciprocally rotate about the blade axis 32 in either of the directions indicated by arrows 34. As will be appreciated by the skilled artisan, a similar mechanism is provided for the blades 16b and 16c.

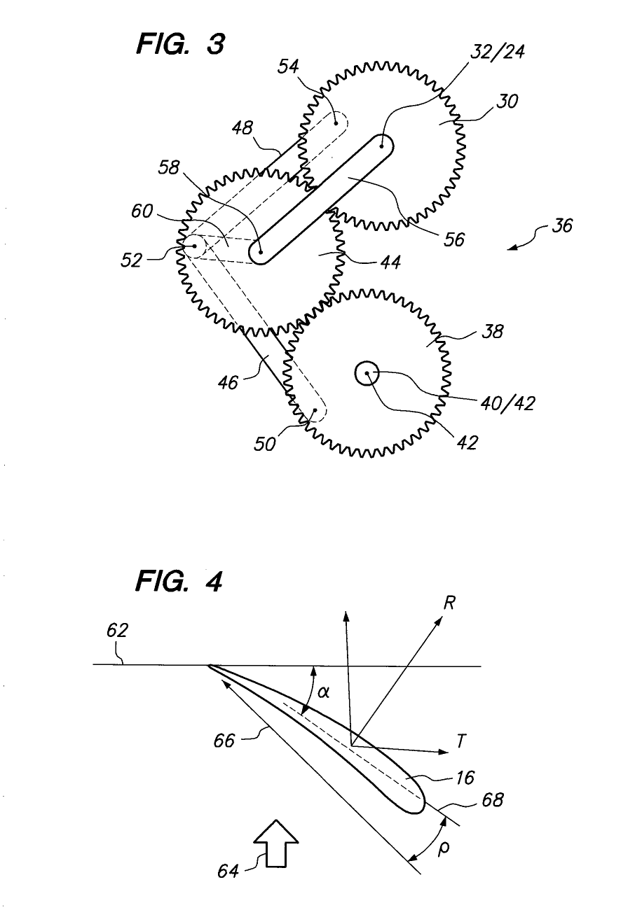

Turning now to FIG. 3, a combination gear/link assembly is shown and is generally designated 36. Although both gears and links are incorporated into this same assembly 36, and though they necessarily operate together, they have slightly different functions. Therefore, depending on the function involved, they are sometimes simply referred to as either the gear assembly 36 or the link assembly 36. With this in mind, FIG. 3 shows the gear assembly 36 includes the blade gear 30 along with a center gear 38. With reference back to FIG. 2, it will be seen that the center gear 38 is affixed to a center shaft 40 for rotation about a central axis 42. A middle gear 44 is provided to intermesh the blade gear 30 with the center gear 38.

Still referring to FIG. 3 it will be seen that the link assembly 36 includes a proximal hub link 46 and a distal hub link 48. Further, it will be seen that one end of the proximal hub link 46 is pivotally attached to a peripheral point 50 on the center gear 38. The other end of the proximal hub link 46 is attached to an end of the distal hub link 48 at a free pivot 52. The other end of the distal hub link 48 is pivotally attached to a connecting post 54 that is mounted on the hub 12 (see FIG. 2). FIG. 3 also shows that the link assembly 36 includes a gear link 56 that interconnects the blade shaft 24 with a center post 58 on the middle gear 44. Also shown is a reference link 60 that interconnects the center post 58 with the free pivot 52.

It is to be appreciated that the respective ends of all links in the link assembly 36 are free to pivot. Specifically, the proximal hub link 46 rotates/pivots about both the peripheral point 50 and the free pivot 52. The distal hub link 48 rotates/pivots about the free pivot 52 and the connecting post 54. Similarly, the gear link 56 rotates/pivots about the blade axis 32 and the center post 58, while the reference link 60 rotates/pivots about the center post 58 and the free pivot 52. Functionally, this structural cooperation (i.e. link assembly 36), together with the gear disclosed above (i.e. gear assembly 36) accomplishes two significant purposes. For one, with the center gear 38 considered as being held stationary, the gears 30, 38 and 44 cooperate to cause a rotation of the blade shaft 24 as the distance between the center shaft 40 (i.e. central axis 42) and the blade shaft 24 (i.e. blade axis 32) is varied. This is the primary function of gear assembly 36. For another, as hub 12 rotates about the hub axis 18, forces are transferred from the connecting post 54 on the hub 12, through the link assembly 36, to the peripheral point 50 on the center gear 38. This will cause the center gear 38 and its center shaft 40 to rotate about the central axis 42. With the gear link 56 and the reference link 60, the link assembly 36 also maintains a mesh engagement for the gears 30, 38 and 44.

With reference back to FIG. 1, it will be appreciated that as the hub 12 rotates about its hub axis 18, the blades 16a-c will follow along a common blade path 62 (represented in FIG. 1 by a dashed line). As mentioned earlier, the movement of the blades 16a-c is the result of a phenomenon known as “autorotation.” Theoretically, autorotation can be briefly explained with reference to FIG. 4. In FIG. 4, the blade 16 is considered to be moving to the right along the blade path 62. This movement, with respect to the tidal flow 64, causes the blade 16 to experience a relative flow 66. A known consequence here is that the blade 16 will establish an incident angle “ρ” with the relative flow 66 (i.e. the angle between the relative flow 66 and the chord line 68 of blade 16). In accordance with well known fluid dynamics this creates a resultant force “R” on the blade 16. Importantly, as shown, the orientation of the force “R” establishes a component “T” of the force “R” that is parallel (or tangent) to the blade path 62. It is this force component “T” that causes the blade 16 to move along the blade path 62 in autorotation. For reference purposes, and to not confuse the incident angle “ρ” disclosed here with the angle “α” referred to elsewhere, it is to be noted that the angle “α” is used to identify the angle between the chord line 68 of respective blades 16a-c and the blade path 62.

### OPERATION

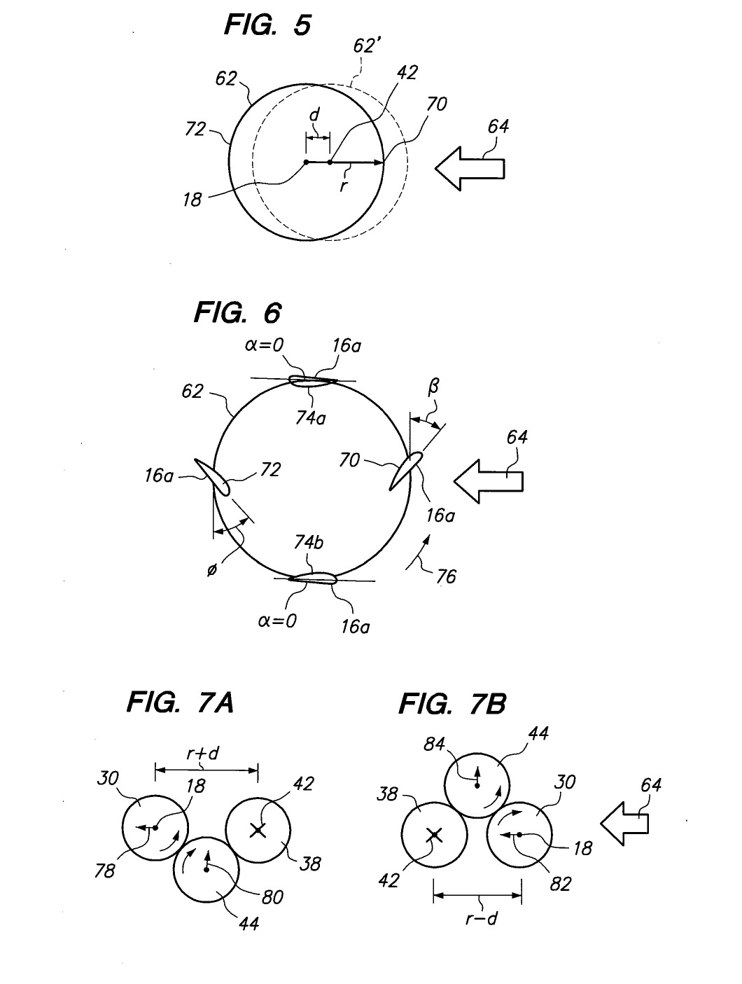

For the operation of the generator 10, the generator 10 is submerged into a body of water which is known to have a substantial and predictable tidal flow 64. Most likely, such a body of water will be in the coastal areas of an ocean or sea, or in a large river. In any event, as mentioned above, the generator 10 is positioned in the body of water so that the central axis 42, the hub axis 18 and the respective blade axes 32 are all substantially perpendicular to the tidal flow 64. Importantly, the generator 10 is anchored to the floor of the body of water so that the central axis 42 remains stationary. When this is done, FIG. 5 indicates that the tidal flow 64 will cause the hub 12 to move with the tidal flow 64 through a distance “d” in a downstream direction from the central axis 42. Preferably, this distance “d” will be less than the radius “r” of the gear (blade path 62). The consequence of this movement is shown in FIG. 5, where representations of the blade path 62 are given under different conditions. For one, with the hub axis 18 co-axially aligned with the central axis 42, the blade path 62′ results. On the other hand, when the hub 12 (i.e. hub axis 18) is moved through the distance “d” under the influence of the tidal flow 64, the blade path 62 results. What this movement of the hub 12 (hub axis 18) does to the individual blades 16a-c will be best appreciated with reference to FIG. 6.

In FIG. 6, the blade 16a (exemplary) is shown traveling along the circular blade path 62 between an upstream position 70 and a downstream position 72. FIG. 6 also shows that as the blade 16a makes a complete revolution by traveling from its upstream position 70, sequentially through a mid-position 74a, the downstream position 72, another mid-position 74b, and back to the upstream position 70, the angle “α” between the chord line 68 of blade 16a and the blade path 62 varies. More specifically, at the upstream position 70, the blade 16a is shown to have a positive angle “β” (β=+α). At the mid-position 74a, however, the angle “α” is shown to be zero. Then, when blade 16a reaches the downstream position 72, the angle “α” becomes a negative angle “φ” (φ=−α). At the mid-position 74b, the angle “α” returns to zero. And, again, at the upstream position 70, the blade 16a is shown to have returned to a positive angle “β” (β=+α). This sequence continues through each revolution of the hub 12 and, importantly, continues regardless of the actual direction of tidal flow 64. The result is a continuous autorotation of the hub 12 in a direction indicated by the arrow 76. The mechanics of rotation for the blade 16a for the above described sequence will be best appreciated with reference to FIGS. 7A and 7B.

The configuration of gear assembly 36 that is shown in FIG. 7A corresponds to conditions at the downstream position 72 (see FIG. 6). Similarly, the configuration of gear assembly 36 in FIG. 7B corresponds to conditions at the upstream position 70 (also see FIG. 6). Consider the downstream position 72 first. As noted above, when blade 16a is at the downstream position 72, the angle “α” becomes a negative angle “φ” (φ=−α). This happens because the tidal flow 64 has moved the hub axis 18 through the distance “d” in the downstream direction (see FIG. 5). Recall, the central axis 42 remains stationary. With this movement, the blade gear 30 moves in the direction of arrow 78 and the distance between the central axis 42 and the hub axis 18 increases to a distance “r+d” (see FIG. 7A). In turn, this causes the middle gear 44 to move in the direction of arrow 80 and to rotate in a clockwise direction. By considering the center gear 38 to remain stationary, the clockwise rotation of middle gear 44 is compensated for by a counterclockwise rotation of the blade gear 30. The result here is that the angle blade 16a makes with the blade path 62 is at its maximum, and is negative (i.e. (φ=−α).

Now consider the upstream position 70 with the gear assembly 36 configured as shown in FIG. 7B. As noted above, when blade 16a is at the upstream position 70, the angle “α” becomes a positive angle “β” (β=+α). In this case, the blade gear 30 has moved in the direction of arrow 82 and the distance between the central axis 42 and the hub axis 18 has decreased to a distance “r−d” (see FIG. 7B). This causes the middle gear 44 to move in the direction of arrow 84 and to rotate in a counterclockwise direction. Again, when considering the center gear 38 remains stationary, the counterclockwise rotation of middle gear 44 is compensated for by a clockwise rotation of the blade gear 30. The result here is that the angle blade 16a makes with the blade path 62 is at its maximum, but is positive (i.e. β=+α). It will be noted that at the mid-positions 74a-b, there will be no effect from tidal flow 64 (i.e. d=0). Consequently, “α” will also be zero.

For purposes of the present invention, the angles β and φ will most likely be equal to each other. Changes to the gear assembly 36, however, can be made to alter this relationship, if desired. For most applications, it is envisioned that the angles β and φ will be in a range between approximately plus thirty degrees and minus thirty degrees.

While the particular Cycloidal Power Generator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for generating power in response to tidal movements, which comprises:
a center shaft defining a central axis;
a hub defining a hub axis, wherein the hub axis is oriented substantially parallel to the central axis;
an elongated blade mounted on the hub for rotation therewith along a circular blade path around the hub axis, wherein the blade defines a blade axis oriented substantially parallel to the hub axis;
a gear assembly interconnecting the blade with the central shaft for rotating the blade about the blade axis to cyclically vary an angle of the blade relative to the blade path in response to a distance and a direction of the hub axis from the central axis to autorotate the blade about the hub axis for rotation of the hub about the hub axis in response to the tidal movement; and
a link assembly interconnecting the hub with the center shaft for rotation of the center shaft in response to a rotation of the hub to generate power.

2. A device as recited in claim 1 wherein the gear assembly comprises:
a center gear affixed to the center shaft for rotation of the center gear about the central axis;
a blade gear affixed to the blade for rotation of the blade gear about the blade axis; and
a middle gear engaged with the center gear and with the blade gear to allow for variations in a distance between the hub axis and the central axis.

3. A device as recited in claim 2 wherein the link assembly comprises:
a proximal hub link having a first end and a second end, with the first end pivotally attached to a peripheral point on the center gear;
a distal hub link having a first end and a second end with the first end pivotally attached to the hub and with the second end thereof pivotally attached to the second end of the proximal hub link to establish a free pivot;
a gear link interconnecting the blade gear with the middle gear; and
a reference link interconnecting the middle gear with the free pivot, wherein the link assembly and the gear assembly, in concert, rotate the center gear and the center shaft when the hub is rotated, and maintain the hub axis at a direction downstream from the central axis relative to the tidal movement.

4. A device as recited in claim 3 wherein the gear assembly reciprocally rotates the blade about its blade axis, during each complete rotation of the hub, to change the angle of the blade relative to its blade path between an angle β and an angle φ to maintain rotation of the hub in a same direction for the generation of power.

5. A device as recited in claim 4 wherein the angle β=+α and the angle φ=−α.

6. A device as recited in claim 3 further comprising a plurality of blades with a respective plurality of gear assemblies and a respective plurality of link assemblies.

7. A device as recited in claim 6 wherein each blade has a first end and a second end, and the first end of each blade is mounted on the hub and wherein the device further comprises an end plate and the second end of each blade is mounted on the end plate.

8. A tidal power generator which comprises:
a hub defining a hub axis;
at least one blade mounted on the hub, wherein the blade defines a blade axis and the blade extends from the hub with its blade axis substantially parallel to the hub axis, for travel along a substantially circular path as the blade establishes an angle relative to the blade path, and wherein the hub is rotated about the hub axis in response to an interaction of the blade with a tidal flow directed substantially perpendicular to the blade axis;
a center shaft defining a central axis;
a link assembly connecting the hub with the center shaft for rotating the center shaft about the central axis in response to a rotation of the hub; and
a gear assembly connecting the blade to the center shaft for reciprocally rotating each blade during each complete rotation of the hub about its blade axis, to change the angle of the blade relative to its blade path between an angle β and an angle φ to maintain rotation of the hub in a same direction for consequent rotation of the center shaft to generate power.

9. A generator as recited in claim 8 wherein the gear assembly comprises:
a center gear affixed to the center shaft for rotation of the center gear about the central axis;
a blade gear affixed to the blade for rotation of the blade gear about the blade axis; and
a middle gear engaged with the center gear and with the blade gear to allow for variations in a distance between the hub axis and the central axis.

10. A generator as recited in claim 9 wherein the link assembly comprises:
a proximal hub link having a first end and a second end, with the first end pivotally attached to a peripheral point on the center gear;
a distal hub link having a first end and a second end with the first end pivotally attached to the hub and with the second end thereof pivotally attached to the second end of the proximal hub link to establish a free pivot;
a gear link interconnecting the blade gear with the middle gear; and
a reference link interconnecting the middle gear with the free pivot, wherein the link assembly and the gear assembly, in concert, rotate the center gear and the center shaft when the hub is rotated, and maintain the hub axis at a direction downstream from the central axis relative to the tidal movement.

11. A generator as recited in claim 8 wherein the gear assembly reciprocally rotates the blade about its blade axis, during each complete rotation of the hub, to change the angle of the blade relative to its blade path between an angle β and an angle φ to maintain rotation of the hub in a same direction for the generation of power.

12. A generator as recited in claim 8 wherein the central axis is substantially parallel to the hub axis, and the gear assembly limits movement of the hub axis from the central axis through a distance “d”.

13. A generator as recited in claim 12 wherein the hub has a radius “r” and “d” is less than “r” (d<r).

14. A generator as recited in claim 13 wherein the angle β=+α and the angle φ=−α.

15. A generator as recited in claim 14 wherein β=0, and φ=0, when d=0.

16. A method for manufacturing a device to generate power from the energy of tidal movements which comprises the steps of:
mounting a plurality of blades on a hub for travel along a common blade path during collective rotation of the blades about a common hub axis, and individual rotation of each blade about a respective blade axis;
positioning a center shaft in a tide, with the center shaft defining a central axis oriented substantially perpendicular to the direction of tidal flow;
connecting the center shaft with each blade via a respective gear assembly for rotating each blade about its blade axis to establish autorotation for the hub in response to the tidal flow over the plurality of blades; and
linking a respective peripheral point on the hub with the center shaft, via a respective link assembly, for rotation of the center shaft to generate power in response to rotation of the hub.

17. A method as recited in claim 16 wherein the gear assembly comprises:
a center gear affixed to the center shaft for rotation of the center gear about the central axis;
a blade gear affixed to the blade for rotation of the blade gear about the blade axis; and
a middle gear engaged with the center gear and with the blade gear to allow for variations in a distance between the hub axis and the central axis.

18. A method as recited in claim 17 wherein the link assembly comprises:
a proximal hub link having a first end and a second end, with the first end pivotally attached to a peripheral point on the center gear;
a distal hub link having a first end and a second end with the first end pivotally attached to the hub and with the second end thereof pivotally attached to the second end of the proximal hub link to establish a free pivot;
a gear link interconnecting the blade gear with the middle gear; and
a reference link interconnecting the middle gear with the free pivot, wherein the link assembly and the gear assembly, in concert, rotate the center gear and the center shaft when the hub is rotated, and maintain the hub axis at a direction downstream from the central axis relative to the tidal movement.

19. A method as recited in claim 16 wherein the gear assembly rotates each blade about its blade axis to cyclically vary an angle of the blade relative to the blade path in response to a distance and a direction of the hub axis from the central axis to autorotate the blade about the hub axis for rotation of the hub about the hub axis in response to the tidal movement.

20. A method as recited in claim 19 wherein the gear assembly reciprocally rotates each blade during each complete rotation of the hub about its blade axis, to change the angle of the blade relative to its blade path between an angle β and an angle φ to maintain rotation of the hub in a same direction for consequent rotation of the center shaft to generate power.
